(19) United States
(12) Patent Application Publication
(10) Pub. No.: US 2026/0145387 A1
(43) Pub. Date: May 28, 2026

(54) PIEZOELECTRIC SENSORS AND METHODS AND APPARATUSES FOR PRODUCING PIEZOELECTRIC SENSORS

(71) Applicant: Purdue Research Foundation, West Lafayette, IN (US)

(72) Inventors: Robert A. Nawrocki, Lafayette, IN (US); Jinsheng Fan, Minneapolis, MN (US); Brittany Newell, Delphi, IN (US); Jose Manuel Garcia-Bravo, West Lafayette, IN (US)

(21) Appl. No.: 19/453,848

(22) Filed: Jan. 20, 2026

Related U.S. Application Data
(62) Division of application No. 18/336,567, filed on Jun. 16, 2023.
(60) Provisional application No. 63/352,844, filed on Jun. 16, 2022.

(51) Int. Cl. B29C 64/30; B29C 64/118; B29C 64/209; B33Y 10/00; B33Y 30/00; B33Y 40/20; B33Y 80/00; G01L 1/16

(52) U.S. Cl. CPC B29C 64/30; B29C 64/118; B29C 64/209; B33Y 10/00; B33Y 30/00; B33Y 40/20; B33Y 80/00; G01L 1/16

(57) ABSTRACT

Piezoelectric devices and methods and apparatus for producing piezoelectric devices. Such a method includes printing a poly(vinylidene fluoride) (PVdF) film having a first side and a second side to form a dielectric, printing a first electrode on the first side of the PVdF film, and printing a second electrode on the second side of the PVdF film. An apparatus for producing a piezoelectric device includes a corona poling apparatus having an anode with an electrically conductive ionizer needle, a cathode spaced apart from and facing the ionizer needle, and a shield surrounding the ionizer needle. The shield focuses ions created during corona discharge toward a location between the ionizer needle and the cathode.

### CROSS-REFERENCE TO RELATED APPLICATIONS

This application claims the benefit of U.S. application Ser. No. 18/336,567 filed Jun. 16, 2023, which claims priority to U.S. Provisional Application 63/352,844 filed Jun. 16, 2022. The contents of these prior patent applications are incorporated herein by reference.

### BACKGROUND OF THE INVENTION

The invention generally relates to methods of manufacturing piezoelectric devices, 3-dimensional (3D) printing devices for use in such a method, and piezoelectric devices produced by such a method.

Piezoelectricity is the generation of electric polarization in a material as the result of applying mechanical stress to the material. Piezoelectricity and piezoelectric materials have found application in the design, construction, and use of actuators, sensors, energy harvesters, and energy sensors. More particularly, piezoelectricity in poly(vinylidene fluoride) (PVdF) has been researched and developed for application as a lead-free alternative to other piezoelectric materials, including for use in actuators and sensors. PVdF is a semi-crystalline thermoplastic polymer characterized by crystalline regions dispersed within amorphous regions.

PVdF offers several advantages to other piezoelectric materials, including favorable environmental and health factors, favorable mechanical properties, easier processing and device design, and lower-cost implementation. Additionally, PVdF exhibits chemical resistance, mechanical resilience, a low dielectric constant, and lower density, all of which are advantageous properties in the applications in which piezoelectric devices and materials are commonly employed. Such characteristics contribute to improved piezoelectric sensor performance, especially greater sensor sensitivity. All of the aforementioned attributes make PVdF films a promising material for use in sensor, sensing, and actuation applications.

PVdF contains polymer chain conformations which appear in three different forms, referred to as α-, β-, and γ-phases. The three forms appear simultaneously, and in different ratios, in a single piece PVdF film. The β-phase has an all-trans (TTTT, often referred to as a “planar zigzag”) conformation and dipole moments that point from the electronegative fluorine to the electropositive hydrogen, which results in a net dipole moment that is nearly normal to the polymer chain. The β-phase is primarily responsible for producing the piezoelectric effect, as the piezoelectric effect is a product of the dipole orientation within the crystalline region. By comparison, the α-phase exhibits a random orientation of dipole moments due to its trans-gauche-trans-gauche (TGTG) conformation. As a result, a PVdF film with more β-phase regions and less α-phase regions is preferable for piezoelectric applications, and the inducing phase transformations from α-phase to β-phase has been extensively studied in both industry and academia.

Inducing transformation of a piezoelectrically inert α-phase region into a piezoelectrically active β-phase region material is a complicated process. Mechanical stretching, thermal annealing, high-voltage electric poling, and electro-spinning are processes often employed in traditional manufacturing methods to orient the molecular dipoles, induce the phase transformation, and thus generate a permanent polarization in fabricated PVdF films. Specifically, commercially available PVdF films are often manufactured through mechanical stretching by a ratio of 3 to 5 and then subjected to a post-processing treatment, such as electric poling, to align the dipoles. The electric poling is performed through contact poling, corona poling, or plasma discharge. However, contact poling is ineffective for 3D printed samples due to the dielectric breakdown, and plasma discharge requires ambient conditions which are difficult to achieve and maintain to be effective, making this method challenging to achieve in standard industrial processes and commensurately difficult to scale. Furthermore, during electro-spinning, the β-phase content is predominantly determined by the solvent type, flow rate, ambient temperature, humidity, and atmosphere. As a result of the inherent difficulty in precisely controlling these factors, and also as a result of the inherent randomness of the semi-crystalline structure of PVdF, there are often considerable variations in the β-phase content in fabricated PVdF products. As a result, there are commensurately significant variations in the dipole alignment and uniformity of such products. Moreover, commercial piezoelectrically active PVdF films are limited to film or fiber-like geometries. As a result of the aforementioned limitations and disadvantages, it is clear that traditional manufacturing processes are inadequate for wide scale application in PVdF fabrication, especially for devices with complex shapes or standalone piezoelectric components.

There are at least two shortcomings in conventional manufacturing methods of PVdF film. PVdF film shapes produced by such methods are constrained to planar or fiber-like geometries, and electric poling must be conducted as part of a post-processing treatment. An alternative to conventional manufacturing processes is 3D printing. Additive 3D printing provides advantages in flexibility in structure design, rapid prototyping, minimal post-processing, and economic feasibility. Researchers have continued to explore the potential advantages provided by combining additive 3D printing with traditional piezoelectric polymer manufacturing processes to fabricate piezoelectric PVdF devices. Due to this being an emerging field, there is not an established industry-wide nomenclature for these processes. Therefore, within the present application, the combination of these processes is referred to as electric poling-assisted additive manufacturing (EPAM).

Previous work and development of EPAM processes have been conducted. One such endeavor created a corona poling electric field by applying a high voltage between the nozzle tip of the extruder and the printing bed of a modified fused deposition modeling (FDM) 3D printer. FDM 3D printers are well known to those with skill in the art. In brief, they rely on an extrusion device to extrude material in fibers on a printing bed, the fibers then comprising the 3D-printed device and fusing, either by natural ambient processes or post-processing, to form a contiguous whole. The EPAM process is capable of printing stand-alone piezoelectric PVdF devices directly while aligning the dipole uniformly over the printing area in a single printing step. However, such a modification required additional electrical insulation between the nozzle and the heater, making the modification prohibitively complex and difficult to apply industrially.

Other investigations have used corona poling to provide electric poling in order to provide a large electric field without also creating a major dielectric breakdown. Because corona ions have very low lateral mobility, only charges in the immediate vicinity of the defect site of 3D printed samples can leak through. This localizing effect mitigates catastrophic dielectric breakdown. The corona poling process also eliminates the need to apply electrodes on samples prior to poling and can be directly integrated into 3D printing processes. Previous investigations have analyzed the effect of extrusion temperature, speed, and in-situ poling voltage on the ratio of β-phase content in PVdF films during the in-situ poling additive manufacturing process. Results demonstrated that a higher β-phase ratio was obtained under faster extrusion rats, a higher poling voltage, and a lower nozzle temperature. Specifically, investigations into the use of EPAM for application in printing piezoelectrically active PVdF-based sensors have been conducted.

While investigations and developments of EPAM processes have been conducted, the integration of 3D printing and traditional PVdF manufacturing processes is still in its infancy, and significant unknowns remain regarding creating an integrated method for producing PVdF devices with EPAM processes, retaining the advantages of both while providing economic and industrial feasibility. Furthermore, there exists a significant gap in equipment suitable for providing such a method.

### BRIEF SUMMARY OF THE INVENTION

The intent of this section of the specification is to briefly indicate the nature and substance of the invention, as opposed to an exhaustive statement of all subject matter and aspects of the invention. Therefore, while this section identifies subject matter recited in the claims, additional subject matter and aspects relating to the invention are set forth in other sections of the specification, particularly the detailed description, as well as any drawings.

The present invention provides, but is not limited to, methods of additive manufacturing of piezoelectric devices, apparatuses capable of performing such methods, and piezoelectric devices produced by such methods.

According to a nonlimiting aspect, a method of additive manufacturing of a piezoelectric device includes printing a poly(vinylidene fluoride) (PVdF) film with a fused deposition modeling (FDM) three-dimensional (3D) printer, and poling the PVdF film using a corona poling apparatus, wherein the printing and poling processes occur simultaneously.

According to another nonlimiting aspect, a piezoelectric device is provided that has been manufactured according to a method as described above.

According to yet another nonlimiting aspect, a fused deposition modeling (FDM) three-dimensional (3D) printer is provided that includes a printing head operable to extrude a material to form a film, a corona poling apparatus adjacent the printing head and operable for poling the film with an electric field, and means operable to cause the corona poling apparatus to move in tandem with the printing head such that the poling of the film occurs simultaneously with extruding of the material to form the film.

Technical aspects of methods, sensors, and apparatuses as described above preferably include the ability to produce a fully 3D-printed flexible poly(vinylidene fluoride) (PVdF) piezoelectric sensor.

These and other aspects, arrangements, features, and/or technical effects will become apparent upon detailed inspection of the figures and the following detailed description.

### BRIEF DESCRIPTION OF THE DRAWINGS

FIG. 1 schematically represents an EPAM 3D printer coupled with a corona poling apparatus configured to generate a corona discharge in a multiple point-to-plane geometry, and further represents a phase transformation from an α-phase to a β-phase of PVdF that can occur during printing of a PVdF film using the 3D printer and corona poling apparatus.

FIG. 2 schematically represents a corona poling apparatus configured to generate a corona discharge in a single point-to-plane geometry, including an electric field and ion flow lines associated therewith.

FIG. 3 schematically represents steps of a 3D printing process for producing a fully 3D printed PVdF device using the 3D printer and corona poling apparatuses of FIGS. 1 and 2.

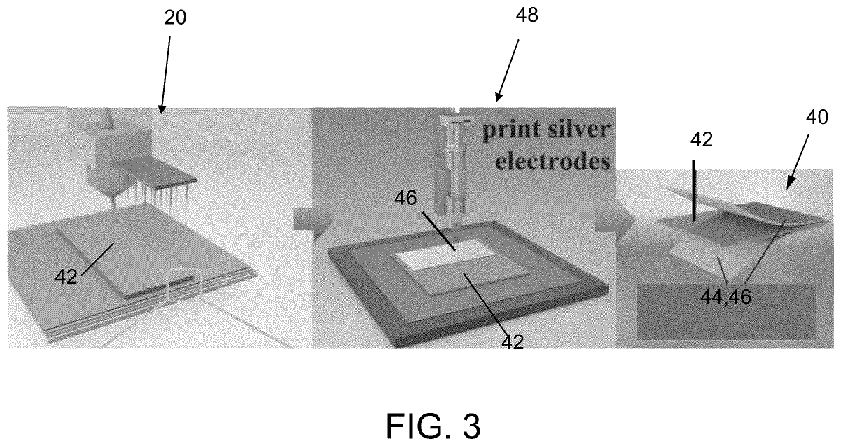

FIG. 4 schematically represents zigzag and one-way poling methods.

FIG. 5 is a schematic diagram of the architecture of a fully 3D printed PVdF force sensing matrix.

### DETAILED DESCRIPTION OF THE INVENTION

The intended purpose of the following detailed description of the invention and the phraseology and terminology employed therein is to describe what is shown in the drawings, which depict and/or relate to one or more nonlimiting embodiments of the invention, and to describe certain but not all aspects of the embodiment(s) depicted in the drawings. The following detailed description also identifies certain but not all alternatives of the embodiment(s) depicted in the drawings. As nonlimiting examples, the invention encompasses additional or alternative embodiments in which one or more features or aspects shown and/or described as part of a particular embodiment could be eliminated, and also encompasses additional or alternative embodiments that combine two or more features or aspects shown and/or described as part of different embodiments. Therefore, the claims, and not the detailed description, are intended to recite what are believed to be aspects of the invention, including certain but not necessarily all of the aspects and alternatives described in the detailed description.

To facilitate the description provided below of the embodiment(s) represented in the drawings, relative terms, including but not limited to, “proximal,” “distal,” “anterior,” “posterior,” “vertical,” “horizontal,” “lateral,” “front,” “rear,” “side,” “forward,” “rearward,” “top,” “bottom,” “upper,” “lower,” “above,” “below,” “right,” “left,” etc., may be used in reference to the orientation of a piezoelectric sensor, fused deposition modeling (FDM) three-dimensional (3D) printer, and corona poling apparatus as represented in the drawings. All such relative terms are useful to describe the illustrated embodiment(s) but should not be otherwise interpreted as limiting the scope of the invention.

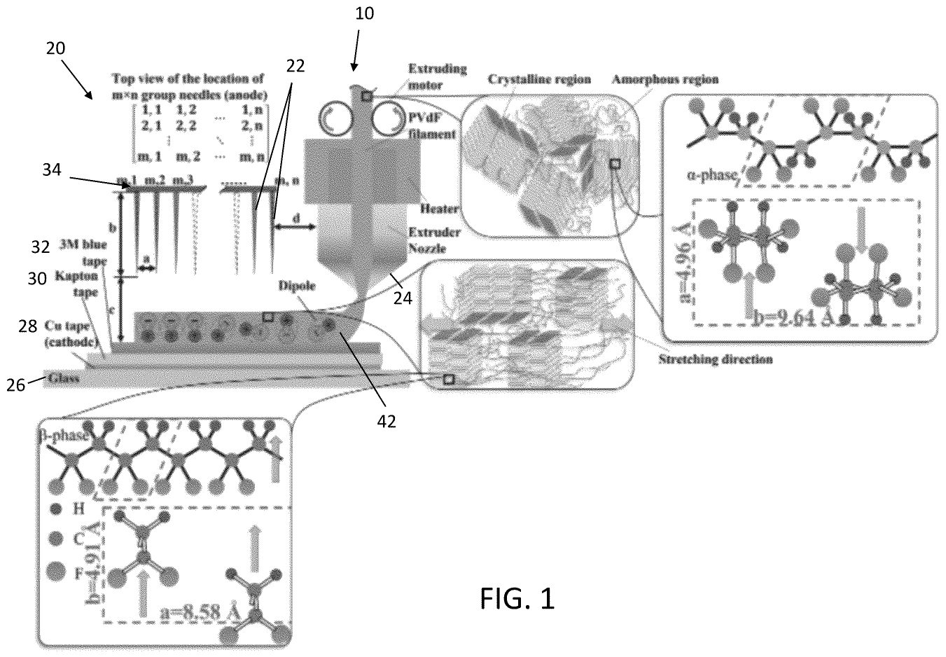

According to a nonlimiting aspect of the present invention, a method for additive manufacturing of a piezoelectric device is provided that includes forming a PVdF film with an FDM 3D printer and simultaneously poling the PVdF film using a corona poling apparatus to provide electric poling in the PVdF film. As schematically represented in FIG. 1, an FDM 3D printer 10 comprises a printing head configured to extrude a PVdF material to form a PVdF film. A corona poling apparatus 20 is adjacent to the printing head and moves in tandem with the printing head such that poling of the PVdF film occurs simultaneously with the extrusion of the PVdF film. As also schematically represented in FIG. 1, during such a method the PVdF film is preferably stretched as it is extruded by the FDM 3D printer 10, thereby rearranging the strands of the PVdF film in the plane and direction of extrusion and allowing an electric field applied by the corona poling apparatus 20 to align dipoles in the same direction. This process enables the printing of free-form PVdF films into complex geometries while inducing the formation of β-phase regions in the PVdF film, thereby improving the piezoelectric characteristics of the PVdF film and a piezoelectric device formed therefrom.

The present invention makes use of an electric poling-assisted additive manufacturing (EPAM) technique that integrates the FDM 3D printer 10 with the corona poling apparatus 20 so as to be capable of printing a piezoelectric PVdF film in a single process. The EPAM technique introduces refined corona poling processing while retaining the advantages of 3D printing, including the ability to stretch PVdF films during printing and provide electric poling under elevated temperatures. As a result, such a method is capable of overcoming shortcomings associated with conventional PVdF manufacturing techniques by allowing PVdF films with complex geometries to be produced while eliminating the need for post-processing to establish electric poling in the PVdF film. By utilizing the electric poling method rather than contact poling, the EPAM technique is capable of eliminating the need to apply electrodes to the PVdF film prior to poling. Finally, by integrating two processes used to produce PVdF films into a single integrated process, significant advantages in design methodology, industrial application and scaling, and end-product quality are achieved.

In some investigations leading to the present invention, an EPAM 3D printer and a corona poling apparatus with a single anode needle were utilized to provide a single point-to-plane geometry (sEPAM). Additional investigations utilized an EPAM 3D printer with multiple point-to-plane geometries (mEPAM) that involved the use of multiple anode needles in the corona poling apparatus, such that electric poling may be provided more uniformly over a wider range of a PVdF film. Comparative advantages of using an sEPAM or mEPAM can be based in part on the intended application of the PVdF film as well as by industrial and economic considerations.

Corona poling was achieved by including at least one anode needle 22 adjacent to the printing head of the EPAM 3D printer 10, more particularly, adjacent to a nozzle 24 of an extruder of the printing head. A high voltage was applied to the one or more needles 22, allowing their function as an anode. The EPAM 3D printer 10 had a printing bed that was grounded, allowing the printing bed to function as a cathode. An electric field was thereby established between the anode needle(s) 22 and the printing bed, allowing the PVdF film printed therebetween while being charged as it was printed. This setup avoided the need for a complicated electrical insulation structure.

The mechanical properties, specifically the bonding surface strength, of a PVdF film produced by such a method are dependent on several factors, including the printing (extrusion) speed and angle. In one nonlimiting investigation, a PVdF film was extruded at 3 millimeters per second (mm/s) and an extrusion angle of 0°, which were experimentally determined to result in a Young's modulus measurement of 534.63 megaPascals (MPa). In another nonlimiting investigation, a PVdF film was extruded at a speed of 20 mm/s and an extrusion angle of 90°, resulting in an ultimate tensile strength (UTS) of 25.35 MPa.

The piezoelectric characteristics of the PVdF film produced as described above are dependent on several factors, including the voltage applied by the corona poling apparatus, the duration of corona poling, and the temperature of the PVdF film during poling. In some of the investigations, corona poling was performed at a voltage of 6.5 kiloVolts (kV) at an ambient temperature of 25° C. for thirty-five minutes, resulting in a piezoelectric activity of 46.62 picoCoulombs per Newton (pC/N) in the PVdF film. In other investigations, poling was performed while the PVdF film was at a printing temperature of about 240° C. to 250° C. The experimental investigations also determined that printing speed had some effect on the piezoelectric characteristics of a PVdF film.

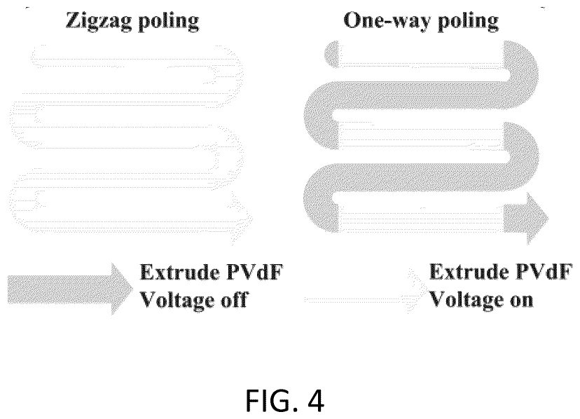

Different piezoelectric qualities may be produced with arrangements of the EPAM 3D printers and corona poling apparatuses described above, depending on the application geometry of electric poling on the PVdF film by the corona poling apparatus. For example, poling can be achieved using a “zigzag” poling method, wherein printing via an extruder nozzle follows a nonlinear zigzag path during which electric poling constantly occurs via the anode needle attached thereto. Alternatively, a one-way poling method can be utilized by printing via an extruder nozzle still follows a nonlinear zigzag path, but in which the electric voltage is applied only when the nozzle (with attached anode needle) is moving in one direction or towards one side, such as from the “left” to “right” side based on a signal orientation of the PVdF film. The voltage is turned off when the nozzle moves in the opposite direction or towards the opposite side, then is turned back on when the direction of movement returns to the original direction. When applying one-way poling, the voltage is turned on and off sequentially depending on the movement of the extruder nozzle and anode needle. FIG. 4 schematically represents an exemplary zigzag poling method and an exemplary one-way poling method.

A significant advantage of arrangements of an EPAM 3D printer and corona poling apparatus as described above is the ability to reduce time required to fabricate a PVdF film. Even if the piezoelectric qualities of a produced PVdF film are equal to or even less than that produced by a PVdF film produced by conventional methods, the ability to produce it in approximately one-half the amount of time confers significant advantages in industrial application, production, and scaling considerations.

FIG. 1 schematically represents the FDM 3D printer 10 as utilized in the investigations. The printer 10 was used to extrude a polymeric filament through the extruder nozzle 24 to form PVdF films on the printing bed. The printer 10 was a MakerBot Replicator 2 3D printer modified to accommodate the corona poling apparatus 20 equipped with an anode needle arrangement 34, also referred to herein as a poling head, which included the one or more corona needles 22 that functioned as anodes (also called anode needles). The distance d between the nearest corona needle 22 and the extruder nozzle 24 was approximately 12 mm. The printing bed of the corona poling apparatus 20 was modified as a plane electrode. The modified printing bed, from the bottom to the top, comprised a glass platform 26, a conductor 28 formed by a 0.08-mm Cu tape, an insulator 30 formed by a 0.20 mm-thick Kapton tape, and an adhesion layer 32 formed by a tape. The conductor 28 acted as a grounded plane on the glass platform 26. The insulator 30 was applied on top of the conductor 28 for electrical insulation. Finally, the adhesion layer 32 (about 0.14 mm in thickness) was placed on top of the insulator 30 to promote adhesion between the printed PVdF films and the printing bed surface. The printing bed of the 3D printer 10 functioned as a bottom electrode (cathode) to the electrically-charged needles 22, serving as an anode. Printing parameters, including extruder nozzle temperature, printing speed, infill angle, and layer thickness, were established using desktop software associated with the printer 10.

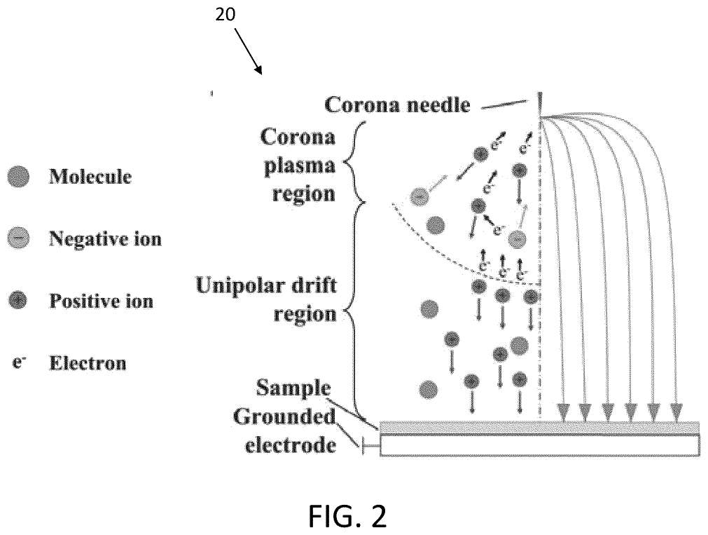

FIG. 1 schematically represents the EPAM 3D printer 10 as equipped with multiple anode needles 22, in which case the EPAM is referred to herein as a multi-point EPAM (mEPAM). In the investigations, a configuration of six anode needles 22 in a two-by-three (2×3) configuration was used. In this configuration, the inter-needle distance was 2.54 mm, the needle length was 5 mm, the distance between the point-to-plane electrodes was 3 mm, and the needle diameters were 0.05 mm. For simplicity in design and industrial application, the printer 10 can instead use a single anode needle 22, in which case the EPAM is referred to herein as a single-point EPAM (sEPAM), to provide a single point-to-plane corona poling apparatus that generates a single point-to-plane electric field. FIG. 2 schematically represents an sEPAM generating a corona discharge in a single point-to-plane geometry, including an electric field and ion flow lines associated therewith. As the electric field strength generated by the corona poling apparatus 10 gets weaker with increasing distance between the center of the anode-cathode configuration, improved poling homogeneity can be achieved by using the multi-point-plane configuration.

FIG. 4 illustrates a nonlimiting embodiment representing various layers of a fully 3D-printed piezoelectric device 40 that can be formed with the printer 10 and corona poling apparatus 20 described above. The device 40 includes a PVdF film 42 printed as a piezoelectric layer with the EPAM-printer 10 using the corona poling apparatus 20, and electrodes 44 and 46 printed on opposite surfaces of the film 42 using a direct ink writing (DIW) printer 48. The device 40 has a sandwiched structure with the piezoelectric PVdF film 42 between the electrodes 44 and 46. In the investigations, the electrodes 44 and 46 were formed of silver and the active area of the device 40 was defined as the overlapped area of the two electrodes 44 and 46, which are capable of storing a charge and producing a voltage potential for piezoelectric output voltage measurement. Therefore, patterning of the electrodes 44 and 46 is significant for defining a specific active area on a piezoelectric layer formed by the continuous PVdF film 42.

A nonlimiting example of a piezoelectric device that can be produced with the printer 10 and corona poling apparatus 20 is a piezoelectric sensor. Such a piezoelectric sensor may be operated as a pressure sensor, wherein in the application of mechanical force on the piezoelectric sensor piezoelectric activity is generated in the sensor, thereby allowing the charge generated therein to be applied in a useful manner. PVdF films are particularly advantageous for application in sensors, as their mechanical properties allow them to endure and respond to routine mechanical stress, attributes which are advantageous in a wide variety of applications.

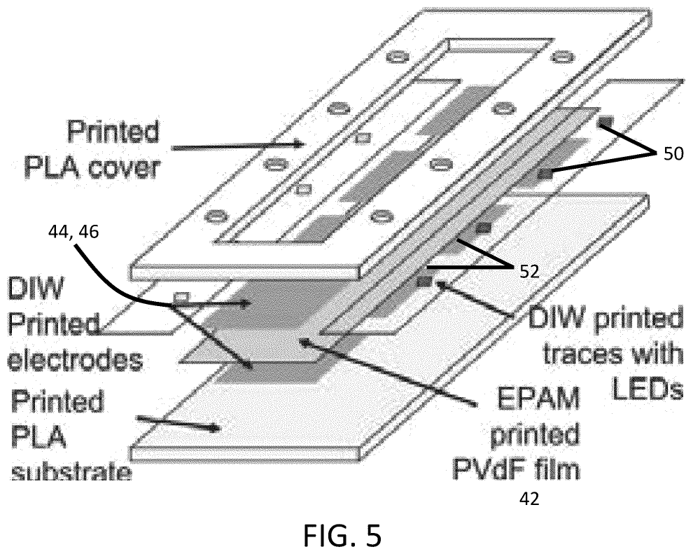

Furthermore, an LED may be operatively coupled with such a sensor and configured to turn on when the piezoelectric layer is subjected to a minimum pressure and turn off when the piezoelectric layer is not subjected to the minimum pressure. To demonstrate such a practical application of a PVdF force sensing device, FIG. 5 schematically represents an example in which light-emitting diodes (LEDs) 50 were integrated into a 3D printed structure with embedded PVdF sensors to visualize a force-sensing capability. The 3D printed structure included a PVdF piezoelectric layer 42 and silver electrodes 44 and 46 sequentially printed on a 3D printed poly(lactic acid) (PLA) substrate. A PLA cover was then printed and installed on the top of the stack as shown in FIG. 5. Finally, surface-mounted LEDs were installed on traces 52 printed on a flexible PET substrate through the DIW process.

The advantageous characteristics of PVdF films produced by such a method, including the quality of their piezoelectric activity and phase ratios, have been verified by Fourier-transform infrared spectroscopy (FTIR) and by analysis of the surface morphology and mechanical properties of the PVdF film. The FTIR results indicate the β-phase content of the PVdF films produced by such a method increased from 15.38% in unpoled 3D-printed PVdF film to 17.14% in EPAM-printed samples.

The average piezoelectric activity of EPAM-printed PVdF films was determined based on the measured piezoelectric output voltage when samples were subjected to a series of known forces normal to the plane of the PVdF extrusion, roughly approximating its piezoelectric activity when subjected to force when in use as a thin-film sensor. The average piezoelectric activity of EPAM-printed PVdF films was measured at 47.76 pC/N, approximately equating to five times the piezoelectric activity of unpoled 3D-printed PVdF films, which were measured at an average of 9.0 pC/N. The analysis indicated that 3D printing in the absence of an electric field does not produce the desirable dipole alignment effect.

As previously noted above, though the foregoing detailed description describes certain aspects of one or more particular embodiments of the invention, alternatives could be adopted by one skilled in the art. For example, aspects of the invention could be used to produce a piezoelectric device that differs in appearance and construction from that shown in the drawings, an EPAM 3D printer and corona poling apparatus could be used that differ in appearance and construction from those shown in the drawings, and various materials could be used in the fabrication of piezoelectric devices other than those noted. As such, and again as was previously noted, it should be understood that the invention is not necessarily limited to any particular embodiment described herein or illustrated in the drawings.

1. A method of additive manufacturing of a piezoelectric device, the method comprising:
printing a poly(vinylidene fluoride) (PVdF) film with a fused deposition modeling (FDM) three-dimensional (3D) printer; and
poling the PVdF film using a corona poling apparatus;
wherein the printing and poling processes occur simultaneously.

2. The method of claim 1, wherein both the forming step and the poling step are achieved by elements of the FDM 3D printer.

3. The method of claim 1, wherein the forming step further comprises stretching the PVdF film as the PVdF film is printed.

4. The method of claim 3, wherein the step of stretching and the step of poling occur simultaneously.

5. The method of claim 1, wherein the step of poling comprises applying a corona field to the PVdF film with the corona poling apparatus having only one anode needle to generate a single point-to-plane electric field.

6. The method of claim 1, wherein the step of poling comprises applying a corona field to the PVdF film with the corona poling apparatus having multiple anode needles to generate a multiple point-to-plane electric field.

7. The method of claim 1, wherein the step of poling comprises one-way poling of the PVdF film wherein the poling occurs only when the corona poling apparatus is moving in a single direction relative to the PVdF film.

8. The method of claim 1, wherein the step of poling comprises zigzag poling of the PVdF film wherein the poling occurs when the corona poling apparatus moves in multiple directions relative to the PVdF film.

9. The method of claim 1, wherein the step of poling comprises creating a poling electric field by applying a high voltage to an anode needle of the corona poling apparatus while a printing bed of the 3D printer is grounded.

10. A fused deposition modeling (FDM) three-dimensional (3D) printer comprising:
a printing head operable to extrude a material to form a film;
a corona poling apparatus adjacent the printing head and operable for poling the film with an electric field; and
means operable to cause the corona poling apparatus to move in tandem with the printing head such that the poling of the film occurs simultaneously with extruding of the material to form the film.

11. The FDM 3D printer of claim 10, wherein the coronal electric poling apparatus comprises:
a poling head comprising at least one anode needle and operatively coupled with the printing head so as to move in tandem with the printing head in a fixed spatial relation to the printing head; and
a printing bed that forms a plane electrode.

12. The FDM 3D printer of claim 11, wherein the at least one anode needle of the poling head comprises a plurality of anode needles.

13. The FDM 3D printer of claim 11, wherein the printing bed comprises:
a bed platform;
a grounding layer disposed on the bed platform;
an insulating layer disposed on the grounding layer; and
an adhesion layer disposed on the insulating layer;
wherein the poling head is spaced apart from the bed platform.

14. The FDM 3D printer of claim 11, wherein the at least one anode needle of the poling head is physically separated at a distance from an extruder nozzle of the printing head through which the material is extruded to form the film.
